(19) United States
(12) Patent Application Publication
(10) Pub. No.: US 2026/0145712 A1
(43) Pub. Date: May 28, 2026

(54) DRIVING TAKEOVER DETECTING METHOD AND SYSTEM THEREOF

(71) Applicant: Automotive Research & Testing Center, Changhua County (TW)

(72) Inventors: Chih-Yuan HSU, Changhua County (TW); Cheng-Cheng HUANG, Changhua County (TW); You-Lun YAN, Changhua County (TW); Yi-Feng SU, Changhua County (TW)

(21) Appl. No.: 18/957,903

(22) Filed: Nov. 25, 2024

(51) Int. Cl. B60W 60/00; B60W 40/08; B60W 50/14; B60W 50/16; G06V 10/70; G06V 20/59; G06V 40/16

(52) U.S. Cl. CPC B60W 60/0053; B60W 40/08; B60W 50/16; G06V 10/70; G06V 20/597; G06V 40/161; G06V 40/172; B60W 2040/0809; B60W 2050/143; B60W 2050/146; B60W 2420/403; B60W 2540/043; B60W 2540/223; B60W 2540/225; B60W 2556/20; B60W 2556/45

(57) ABSTRACT

A driving takeover detecting method is for determining whether a driver located on a driver's seat in a vehicle satisfies a driving takeover condition in a self-driving mode. The driving takeover detecting method includes an image capturing step, a face feature detecting step, a confidence level determining step, a driver availability detecting step and a driving takeover determining step. The confidence level determining step includes determining whether a comprehensive confidence level is greater than or equal to a confidence level threshold based on the at least one face detection result by a confidence level determination module. The driver availability detecting step includes, by an availability determination module, determining whether the driver satisfies an availability condition, which is an availability determination result, after the comprehensive confidence level is determined to be greater than or equal to the confidence level threshold in the confidence level determining step.

### BACKGROUND

### Technical Field

The present disclosure relates to a driving takeover detecting method and a system thereof. More particularly, the present disclosure relates to a driving takeover detecting method and a system thereof based on driver images.

### Description of Related Art

While the self-driving market is growing, how to improve the safety to reduce the occurrence of accidents thereof is always a priority consideration in the development of self-driving vehicles. For Level 3 self-driving vehicles of SAE (Society of Automation Engineers), the driver is not required to hold the steering wheel under certain conditions. However, the driver must have the ability to take over the driving task. Therefore, the development focus of Level 3 self-driving vehicles is to detect whether the driver is conscious and can take over the driving task at any time, rather than focusing on detecting the driver's concentration as Level 0 to Level 2 self-driving modes.

Given the above, how to develop a driving takeover detecting method and a system thereof, which can appropriately and accurately detect whether a driver of a Level 3 self-driving vehicle has an ability to take over the driving task, has become an urgent issue in the self-driving market.

### SUMMARY

According to one aspect of the present disclosure, a driving takeover detecting method is for determining whether a driver located on a driver's seat in a vehicle satisfies a driving takeover condition in a self-driving mode. The driving takeover detecting method includes an image capturing step, a face feature detecting step, a confidence level determining step, a driver availability detecting step and a driving takeover determining step. The image capturing step includes capturing a plurality of driver images of the driver by at least one camera. The face feature detecting step includes, based on the driver images, by a detection module, detecting whether the driver satisfies at least one face feature threshold, which is at least one face detection result. The confidence level determining step includes determining whether a comprehensive confidence level is greater than or equal to a confidence level threshold based on the at least one face detection result by a confidence level determination module. The driver availability detecting step includes, by an availability determination module, determining whether the driver satisfies an availability condition, which is an availability determination result, after the comprehensive confidence level is determined to be greater than or equal to the confidence level threshold in the confidence level determining step. The driving takeover determining step includes determining whether the driving takeover condition is satisfied based on the availability determination result.

According to another aspect of the present disclosure, a driving takeover detecting system includes a self-driving unit, at least one camera, a local processing unit and a vehicle communication network. The self-driving unit is disposed in a vehicle and configured for executing a self-driving mode of the vehicle. The at least one camera is disposed in the vehicle and configured for capturing a plurality of driver images of a driver located on a driver's seat in the vehicle. The local processing unit is disposed in the vehicle and includes a detection module, a confidence level determination module and an availability determination module. The vehicle communication network is disposed in the vehicle and configured for communicatively connecting the self-driving unit, the at least one camera and the local processing unit. The local processing unit is configured to: capture the driver images of the driver by the at least one camera; based on the driver images, by the detection module, detect whether the driver satisfies at least one face feature threshold, which is at least one face detection result; determine whether a comprehensive confidence level is greater than or equal to a confidence level threshold based on the at least one face detection result by the confidence level determination module; by the availability determination module, determine whether the driver satisfies an availability condition, which is an availability determination result, after the comprehensive confidence level is determined to be greater than or equal to the confidence level threshold; and determine whether a driving takeover condition is satisfied based on the availability determination result.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a driving takeover detecting method according to the first embodiment of the present disclosure.

FIG. 2 is a schematic view of a face feature detecting step of the driving takeover detecting method in FIG. 1.

FIG. 3 is a schematic view of a multi-task detection framework of the driving takeover detecting method in FIG. 1.

FIG. 4 is a block diagram of a driving takeover detecting system according to the second embodiment of the present disclosure.

FIG. 5 is a schematic view of the driving takeover detecting system in FIG. 4.

### DETAILED DESCRIPTION

Embodiments of the present disclosure will be described below with reference to the drawings. For the sake of clarity, many practical details will be explained together in the following statements. However, it should be understood that these practical details should not be used to limit the present disclosure. That is, these practical details are not necessary in embodiments of the present disclosure. In addition, for the sake of simplifying the drawings, some commonly used structures and components are shown in the drawings in a simple schematic manner; and repeated components may be represented by the same numbers.

In addition, the terms first, second, etc. are used herein to describe various elements or components, these elements or components should not be limited by these terms. Consequently, a first element or component discussed below could be termed a second element or component. Moreover, the combination of components in the present disclosure is not a combination that is generally known, conventional or customary in this field. The components themselves being or being not common knowledge cannot be used to determine whether the combination relationship can be easily completed by a person skilled in the technical field.

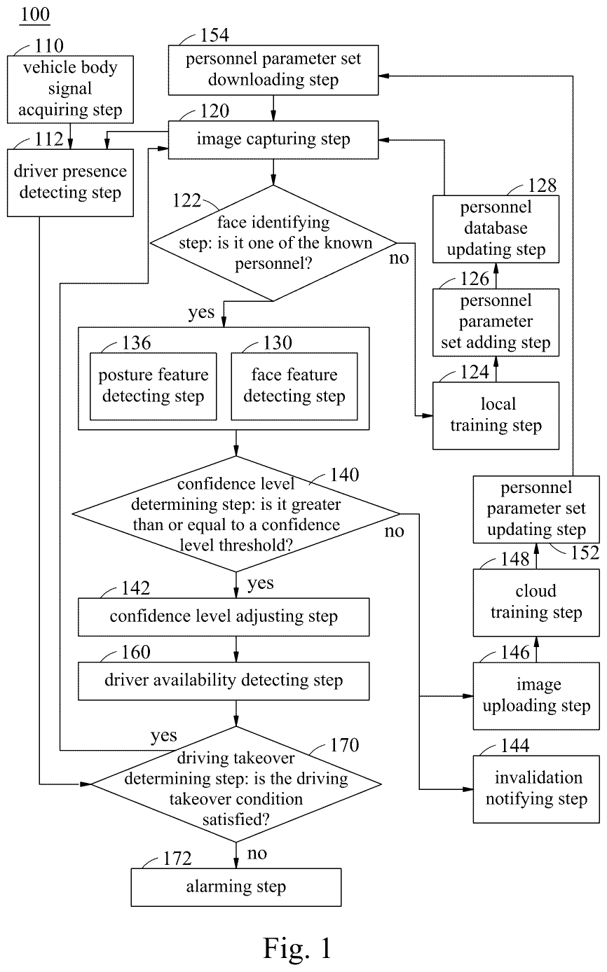

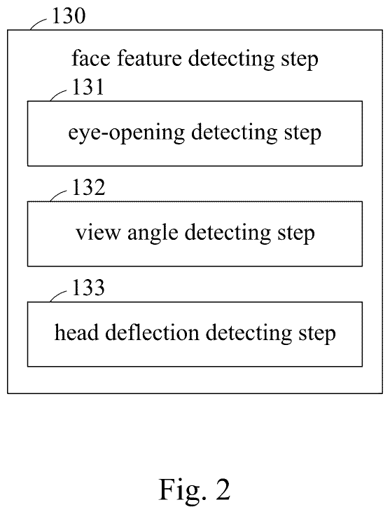

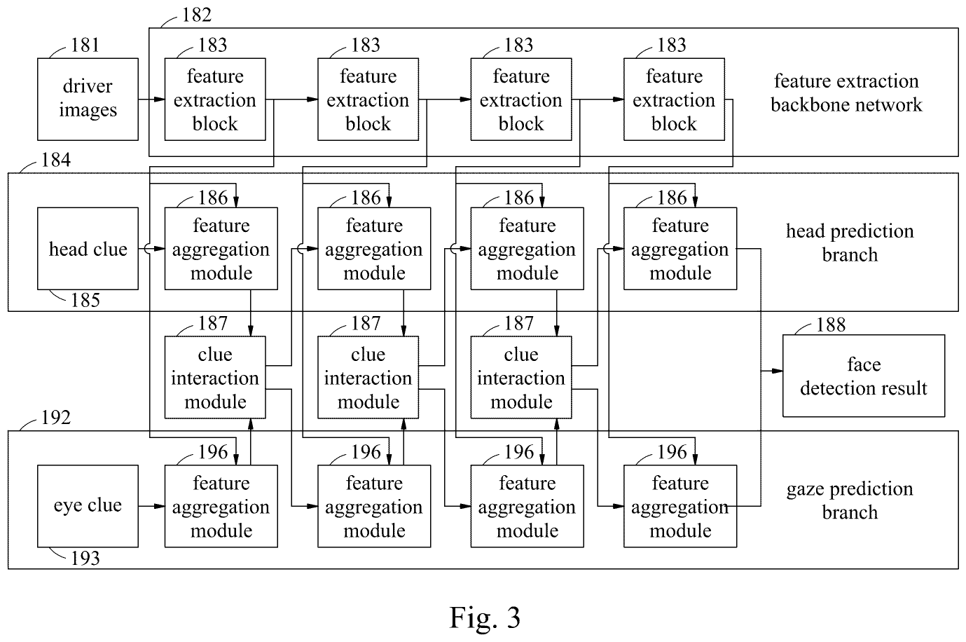

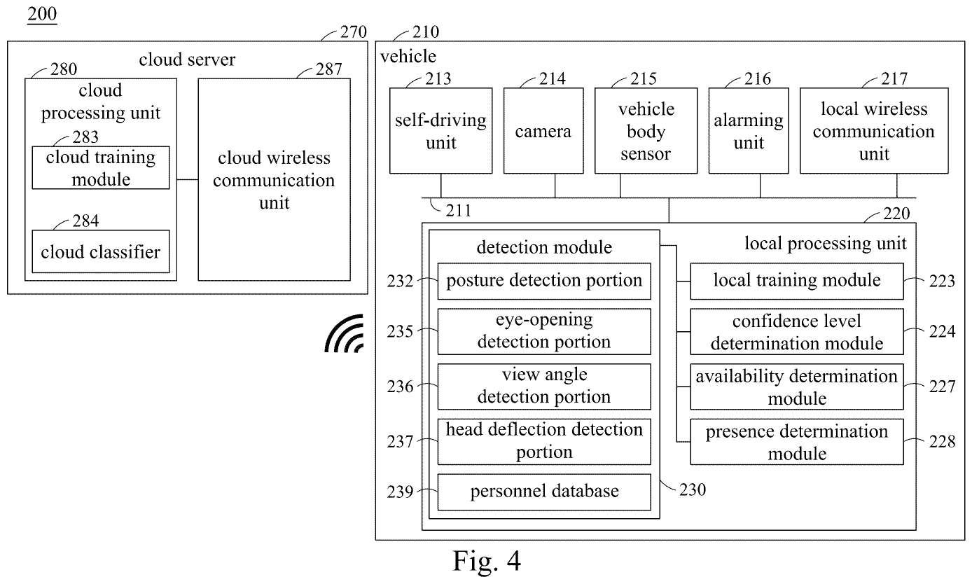

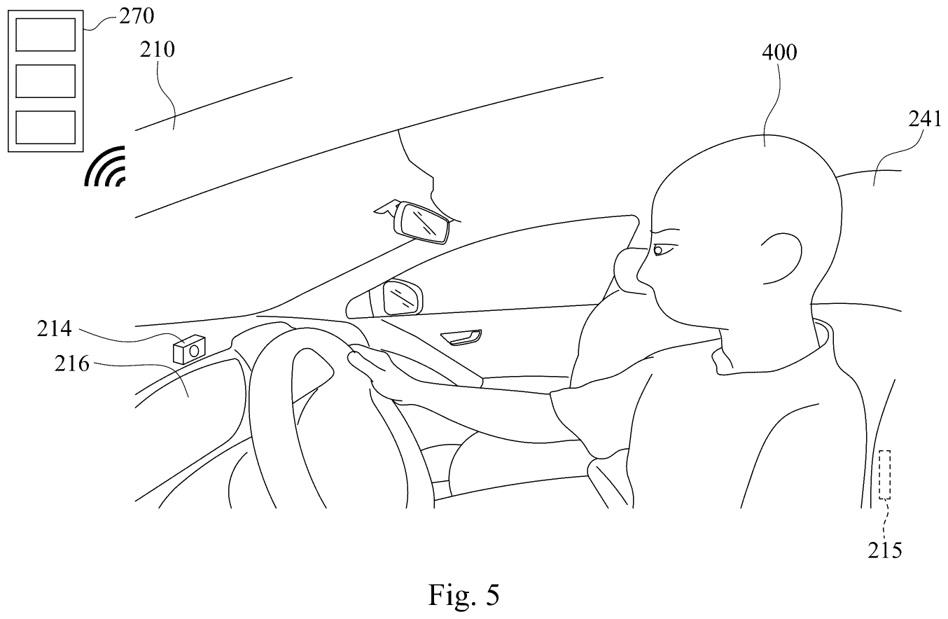

FIG. 1 is a flow chart of a driving takeover detecting method 100 according to the first embodiment of the present disclosure, FIG. 2 is a schematic view of a face feature detecting step 130 of the driving takeover detecting method 100 in FIG. 1, FIG. 3 is a schematic view of a multi-task detection framework of the driving takeover detecting method 100 in FIG. 1, FIG. 4 is a block diagram of a driving takeover detecting system 200 according to the second embodiment of the present disclosure, and FIG. 5 (not shown in actual scale) is a schematic view of the driving takeover detecting system 200 in FIG. 4. With reference to FIG. 1 to FIG. 5, the driving takeover detecting method 100 of the first embodiment is explained in assistance with the driving takeover detecting system 200 of the second embodiment. It is noted that the driving takeover detecting method 100 according to the present disclosure is not limited to implementation in the driving takeover detecting system 200, and the driving takeover detecting system 200 according to the present disclosure is not limited to use the driving takeover detecting method 100. The driving takeover detecting method 100 of the first embodiment is for determining whether a driver (e.g., a driver 400) located on a driver's seat 241 in a vehicle 210 satisfies a driving takeover condition in a self-driving (autonomous) mode. The driving takeover detecting method 100 includes an image capturing step 120, a face feature detecting step 130, a confidence level determining step 140, a driver availability detecting step 160 and a driving takeover determining step 170.

The image capturing step 120 includes capturing a plurality of driver images (image frames) 181 of the driver 400 by at least one camera 214. Specifically, in order to be used in both situations of daytime and night with insufficient light, the driver images 181 captured by the camera 214 may be infrared night vision images, and the camera 214 may have an active infrared fill light function. In addition, the camera 214 may be a depth camera. The face feature detecting step 130 includes, based on the driver images 181, by a detection module 230, detecting whether the driver 400 satisfies at least one face feature threshold (threshold value), which is at least one face detection result 188. The confidence level determining step 140 includes determining whether a comprehensive confidence level is greater than or equal to a confidence level threshold based on the face detection result 188 by a confidence level determination module 224. The driver availability detecting step 160 includes, by an availability determination module 227, determining (detecting) whether the driver 400 satisfies an availability condition, which is an availability determination result, after (when) the comprehensive confidence level is determined to be greater than or equal to the confidence level threshold in the confidence level determining step 140. The driving takeover determining step 170 includes determining whether the driving takeover condition is satisfied based on the availability determination result. Therefore, the driving takeover detecting method 100 according to the present disclosure adapts the confidence level as an update criterion for model updating, so as to be suitable for changing and complex environments and scenes.

In detail, the detection module 230 may include a personnel database 239, which includes a plurality of personnel parameter sets respectively corresponding to a plurality of known personnel. Each of the personnel parameter sets includes a plurality of characteristic parameter values. The driving takeover detecting method may further include a face identifying step 122 and a posture feature detecting step 136. The face identifying step 122 includes identifying whether the driver 400 is one of the known personnel. The posture feature detecting step 136 includes, based on the driver images 181, by a posture detection portion 232 of the detection module 230, detecting whether the driver 400 satisfies at least one posture feature threshold, which is at least one posture detection result. Specifically, the at least one posture feature threshold may include a head placement angle threshold, a torso placement angle threshold and a hand posture threshold, and the at least one posture detection result may include a head placement angle detection result, a torso placement angle detection result and a hand posture detection result. After the driver 400 is identified as one of the known personnel in the face identifying step 122, the face feature detecting step 130 and the posture feature detecting step 136 are executed. The confidence level determining step 140 includes determining whether the comprehensive confidence level is greater than or equal to the confidence level threshold based on the at least one face detection result 188 and the posture detection results by the confidence level determination module 224. Therefore, whether the driver 400 is in an awake state or a distracted state can be further determined in the face feature detecting step 130 and the posture feature detecting step 136. For example, it can be detected whether the driver 400 satisfies the condition of maintaining the same posture for more than a preset time (which can be between 5 seconds and 10 minutes) or whether the nodding condition is satisfied in the face feature detecting step 130 and the posture feature detecting step 136. If it is satisfied, it is determined that the driver 400 is not in an awake state. If it is not satisfied, it is determined that the driver 400 is in an awake state. When it is determined that the driver 400 is in the awake state, key feature points such as the left eye, right eye, left ear, right ear, nose, left shoulder and right shoulder of the driver 400 can be further detected to determine whether the driver 400 is in a distracted state.

The driving takeover detecting method 100 may further include a local training step 124, a personnel parameter set adding step 126 and a personnel database updating step 128. After the driver 400 is not identified as one of the known personnel in the face identifying step 122, the local training step 124 is executed. The local training step 124 includes using the driver images 181 to train the detection module 230 by a local training module 223, and the local training module 223 is a machine learning algorithm. The personnel parameter set adding step 126 includes adding a personnel parameter set corresponding to the driver 400 to the personnel database 239. The personnel database updating step 128 includes updating the personnel database 239. The image capturing step 120 is executed after the personnel database updating step 128 is executed. Therefore, the local training step 124 is to use a small number of multi-task models to train and calculate the feature thresholds to perform local personalized parameter learning. Different drivers have different thresholds for their faces (such as the view angles, the head deflection angles, etc.) and postures during driving. The factors that affect the thresholds may be the driver's height, body shape, face shape, seating habit, driving behavior, or the vehicle's mechanism design and installation location.

In order for the driving takeover detecting method 100 to be able to deal with various drivers without the need to manually adjust the threshold for each driver, when the driver 400 is not identified as one of the known personnel in the face identifying step 122, the driving takeover detecting system 200 is configured to instruct the driver 400 to look at designated locations in the cockpit through voice or images. The designated locations may be the rear mirror, left rear mirror, right rear mirror, carputer, steering wheel, instrument panel, and glove compartment, etc. (not limited thereto), and the view angle, head deflection angle, etc. detected within a fixed time period are acquired. Next, according to the type of detection, the maximum value or the minimum value is set as a threshold, and a personnel parameter set corresponding to the driver 400 is added to the personnel database 239 in the local training step 124 and the personnel parameter set adding step 126. Furthermore, the local-side personalized parameter learning in the driving takeover detecting method 100 is for the driver 400 to improve the availability detection of the driver 400. It is trained locally and can be used only by the vehicle 210, and is not shared with other vehicles. In addition, the local personalized parameter learning in the driving takeover detecting method 100 can include registering with the personal data to the personnel parameter database in the cloud server 270 (not on the vehicle) and combining with the vehicle parameter database of the vehicle 210, e.g., the installation position of the camera 214, seat information, etc., and OTA (over the air) download technology, to carry out the personalized parameter learning in the vehicle 210 or the cloud server 270, so as to achieve the detection accuracy of driving availability for the driver 400 on different vehicles.

The detection module 230 may include an eye-opening detection portion 235, a view angle (line of sight) detection portion 236 and a head deflection detection portion 237. The face feature detecting step 130 may include an eye-opening detecting step 131, a view angle detecting step 132 and a head deflection detecting step 133. The eye-opening detecting step 131 includes, based on the driver images 181, by the eye-opening detection portion 235, detecting whether the driver 400 satisfies an eye-opening feature threshold, which is an eye-opening detection result. The view angle detecting step 132 includes, based on the driver images 181, by the view angle detection portion 236, detecting whether the driver 400 satisfies a view angle feature threshold, which is a view angle detection result. The head deflection detecting step 133 includes, based on the driver images 181, by the head deflection detection portion 237, detecting whether the driver 400 satisfies a head deflection feature threshold, which is a head deflection detection result. Furthermore, the head deflection detecting step 133 of the face feature detecting step 130 is calculated based on the face feature points, and the head placement detecting step of the posture feature detecting step 136 is calculated based on the relationships between the head feature points and the human torso, for example, calculated based on the relationships between the head feature points and shoulders. A number of the at least one face detection result 188 is at least three, and the face detection results 188 include the eye-opening detection result, the view angle detection result and the head deflection detection result. The confidence level determining step 140 includes calculating an eye-opening confidence level, a view angle confidence level, a head deflection confidence level and a posture confidence level respectively based on the eye-opening detection result, the view angle detection result, the head deflection detection result and the posture detection result by the confidence level determination module 224, and calculating the comprehensive confidence level based on the eye-opening confidence level, the view angle confidence level, the head deflection confidence level and the posture confidence level by the confidence level determination module 224. Therefore, by the camera 214 and the detection module 230 (artificial intelligence multi-task detection model), multiple physiological signs (face, eye state, line of sight, head posture, human body posture, etc.) of the driver 400 are obtained, thereby a personalized detection model for the driver 400 can be developed to adapt to changing and complex environments and scenes, improving the safety of the Level 3 self-driving system in taking over driving tasks.

With reference to FIG. 3, the driving takeover detecting method 100 adopts a multi-task detection framework, which includes a feature extraction backbone network 182, a head prediction branch 184 and a gaze prediction branch 192. The head prediction branch 184 is corresponding to the face feature detecting step 130 and the posture feature detecting step 136, and the gaze prediction branch 192 is corresponding to the face feature detecting step 130. Furthermore, the feature extraction backbone network 182 of the driving takeover detecting method 100 uses MobileNet V2 to perform lightweight feature extraction, and connects each prediction branch to the feature extraction block 183 of the feature extraction backbone network 182 to obtain the features required for task prediction. After the driver images 181 is obtained in the image capturing step 120, head cues 185 and eye cues 193 are extracted to perform prediction of various tasks such as the head posture and the face key points. In the process, by the feature aggregation modules 186,196 and the clue interaction module 187, the feature extraction backbone network 182 is fused with the features at different stages of the two prediction branches, and it is finally inputted into the prediction module of the respective downstream tasks and the face detection results 188 are outputted.

With reference to FIG. 1, FIG. 2, FIG. 4 and FIG. 5, in the confidence level determining step 140, the eye-opening confidence level, the view angle confidence level, the head deflection confidence level and the posture confidence level respectively have an eye-opening weight, a view angle weight, a head deflection weight and a posture weight for calculating the comprehensive confidence level by the confidence level determination module 224. Each of the eye-opening weight and the view angle weight is greater than each of the head deflection weight and the posture weight. The characteristic parameter values of the personnel parameter set corresponding to each of the known personnel include the eye-opening feature threshold, the view angle feature threshold, the head deflection feature threshold, the posture feature threshold, the eye-opening weight, the view angle weight, the head deflection weight and the posture weight. Therefore, since eye opening and view angle are closely related to safe driving behavior, the eye-opening weight and the view angle weight need to be greater than the head deflection weight and the posture weight to ensure the calculation accuracy of the confidence level. In addition, each of the eye-opening weight, the view angle weight, the head deflection weight and the posture weight is between 0.2 and 0.6. The eye-opening weight may be greater than, equal to, or less than the view angle weight. The sum of eye-opening weight, the view angle weight, the head deflection weight and the posture weight is 1.

For example, the head deflection feature threshold is that the head deflection angle is between −5 degrees and 5 degrees (0 degrees is defined that the head of the driver 400 is facing straight ahead). The view angle feature threshold is that the view angle is between −45 degrees and 45 degrees (0 degrees is defined that the driver 400 is looking straight ahead, and the positive direction of the view angle can be defined to the left or the right). The eye-opening confidence level that satisfies and does not satisfy the eye-opening feature threshold is 1 point and 0 points, respectively (there can also be more point levels). The view angle confidence level that satisfies and does not satisfy the view angle feature threshold is 1 point and 0 points, respectively. The head deflection confidence level that satisfies and does not satisfy the head deflection feature threshold is 1 point and 0 points, respectively. The posture confidence level that satisfies and does not satisfy the posture feature threshold is between 0 points and 1 point and has multiple point levels. The eye-opening weight and the view angle weight are both 0.3, and the head deflection weight and posture weight are both 0.2. It can be defined as “the comprehensive confidence level=the eye-opening weight×the eye-opening confidence level+the view angle weight×the view angle confidence level+the head deflection weight×the head deflection confidence level+the posture weight×the posture confidence level”. The confidence level threshold can be between 0.2 and 0.6, and the confidence level threshold can be specifically 0.4.

At least one of the eye-opening feature threshold, the view angle feature threshold, the head deflection feature threshold and the posture feature threshold may have thresholds respectively applicable to an unobstructed face state and at least one obstructed face state, and the obstructed face state indicates a face of the driver 400 is obstructed by an object. Therefore, the driving takeover detecting method 100 is featured with an online deep learning mechanism, which can solve the problem of losing the features of the driver 400 due to light source of the camera 214 or object obstruction, and can detect different drivers. Thus, the accuracy can be improved under the daytime, night, low light, profile, and face accessories (such as masks, glasses, sunglasses, hats, but not limited thereto), and it is beneficial for changing and complex environments and scenes, improving the safety of Level 3 self-driving systems in taking over driving tasks by the driver 400.

With reference to FIG. 1, FIG. 4 and FIG. 5, the driving takeover detecting method 100 may further include an invalidation notifying step 144, an image uploading step 146, a cloud training step 148, a personnel parameter set updating step 152 and a personnel parameter set downloading step 154. After the comprehensive confidence level is determined to be less than the confidence level threshold in the confidence level determining step 140, the invalidation notifying step 144 and the image uploading step 146 are executed. The invalidation notifying step 144 includes notifying the driver 400 that the driving takeover detecting system 200 cannot operate normally by the alarming unit 216 of the vehicle 210 with at least one of a visual manner, an auditory manner and a vibration manner. For example, the visual manner can be text messages displayed on the carputer screen, the auditory manner can be warning sound effects or warning voices, and the vibration manner can be driver seat vibration or steering wheel vibration, but not limited thereto. The image uploading step 146 includes encrypting and then uploading the driver images 181 to a cloud server 270. The cloud training step 148 includes using the driver images 181 to train a cloud classifier 284 by a cloud training module 283, the cloud classifier 284 is similar to or configured for updating the detection module 230, and the cloud training module 283 is a machine learning algorithm. The personnel parameter set updating step 152 includes updating one of the personnel parameter sets corresponding to the driver 400 of the cloud classifier 284. The personnel parameter set downloading step 154 includes downloading the updated personnel parameter set corresponding to the driver 400 of the cloud classifier 284 to the detection module 230 via OTA download technology. Furthermore, the confidence level threshold is based on a minimum confidence value that is positive in a confusion matrix. Therefore, the model can be updated for changing and complex environments and scenes. In addition, the “multi-task model online/continuous learning” of the driving takeover detecting method 100 is mainly to detect the features of the personnel, so it is not limited to the vehicle model and driver. Its training can be done locally or in the cloud, and the parameters of the multi-task model are shared via cloud updates and OTA download technology, so that the vehicles used can adapt to various situations, such as light changes and faces being (severely) obstructed.

For example, the driving takeover detecting method 100 according to the present disclosure can achieve below. When the driver 400 is in the focused driving state required by Level 3 and faces the camera 214 with the face, the comprehensive confidence level is determined to be greater than or equal to the confidence level threshold in the confidence level determining step 140. When the driver 400 is not in the focused driving state required by Level 3 and faces the camera 214 with the face, the comprehensive confidence level is determined to be less than the confidence level threshold in the confidence level determining step 140, then, the image uploading step 146 and the cloud training step 148 are performed in sequence, and it is determined not to update one of the personnel parameter sets corresponding to the driver 400 of the cloud classifier 284 in the personnel parameter set updating step 152.

The cloud training step 148 may include fixing a part of the characteristic parameter values of one of the personnel parameter sets to train the cloud classifier 284 by the cloud training module 283, and the personnel parameter set updating step 152 may include updating another part of the characteristic parameter values of the one of the personnel parameter sets of the cloud classifier 284. Therefore, the driving takeover detecting method 100 based on the present disclosure mainly uses the camera 214 and artificial intelligence technology to detect the status of the driver 400, and adds an online deep learning mechanism to optimize the driving status detection technology in the cockpit and improve its determination accuracy. Moreover, the personalized detection model (i.e., the personnel parameter set in the personnel database 239) of the driver 400 is developed to be used for changing and complex environments and scenes, and improve the safety of the Level 3 self-driving system in taking over driving tasks by the driver 400.

The cloud training step 148 may include labeling the driver images 181 and using the labeled driver images 181 to determine the part being fixed of the characteristic parameter values. Therefore, fine-tuning network parameters of small sample is advantageous in achieving better results. In addition, continuous learning technology, such as experience replay, is used in the cloud training step 148 to learn new material so as to reduce the occurrence of catastrophic forgetting.

The driving takeover detecting method 100 may further include a confidence level adjusting step 142. After the comprehensive confidence level is determined to be greater than or equal to the confidence level threshold in the confidence level determining step 140, the confidence level adjusting step 142 is executed. The confidence level adjusting step 142 includes increasing or decreasing the comprehensive confidence level based on a ratio and a duration of an appearance of a same image or a similar image in the driver images 181. Therefore, it is beneficial for improving the accuracy of the subsequent driver availability detecting step 160 and the driving takeover determining step 170.

With reference to FIG. 1, FIG. 4 and FIG. 5, the driving takeover detecting method 100 may further include a vehicle body signal acquiring step 110, a driver presence detecting step 112 and an alarming step 172. The vehicle body signal acquiring step 110 includes acquiring a plurality of vehicle body signals of the driver's seat 241 by at least one vehicle body sensor 215. The vehicle body signals include at least partial signals of a plurality of seat belt buckle signals and a plurality of driver's seat pressure signals. Furthermore, the vehicle body sensor 215 can be installed on the driver's safety buckle or on/inner the driver's seat, but is not limited thereto. When the vehicle body sensor 215 is installed on/inner the driver's seat, it can be installed on/inner the seat cushion, seat back, or a combination thereof, and is not limited to being installed on the inner layer or surface of the driver's seat. The driver presence detecting step 112 includes, based on at least one of the driver images 181 and the vehicle body signals, by a presence determination module 228, determining (detecting) whether the driver 400 satisfies a presence condition, which is a presence determination result. The driving takeover determining step 170 includes determining whether the driving takeover condition is satisfied based on the availability determination result and the presence determination result. After the driving takeover condition is not satisfied in the driving takeover determining step 170, the alarming step 172 is executed. In other words, if one of the availability determination result and the presence determination result does not satisfy the driving takeover condition, the alarming step 172 will be executed. The alarming step 172 includes generating at least one of a visual alarm, an auditory alarm and a vibration alarm to alarm the driver 400. Therefore, after executing the alarming step 172, if it is determined that the driver 400 does not have the ability to control the vehicle 210, the self-driving unit 213 will enter the “minimum risk control mechanism”, which is intended to slow the vehicle 210 to stop or park to the side of the road. In addition, according to an embodiment of the disclosure (not shown), the driving takeover detecting method includes determining whether the driver maintains a focused state when the driver switches the manual driving mode to the self-driving mode. If it is determined that driver is not focused, the alarming step will be performed and the switch to the self-driving mode will be prohibited.

The image uploading step 146 may be executed after the self-driving mode ends or the engine is turned off. The image capturing step 120 may be executed after the personnel parameter set downloading step 154 is executed. Therefore, when the comprehensive confidence level is lower than the confidence level threshold, the images related to the human body posture and face characteristic parameters will be captured and stored, and the image frames will be re-entered into the cloud learning system to achieve the effect of online learning and increase the detection accuracy of posture and face features, such as enhancing the detection accuracy and reliability of non-frontal faces. In addition, in the local training step 124, a small number of multi-task models are used to train and calculate feature thresholds, which helps to store face feature thresholds and personalized multi-task model weights into the current driver number in the subsequent steps.

With reference to FIG. 4 and FIG. 5, the driving takeover detecting system 200 according to the present disclosure includes the self-driving unit 213, the camera 214, a local processing unit 220 and a vehicle (on-board) communication network 211. The self-driving unit 213 is disposed in the vehicle 210 and configured for executing the self-driving mode of the vehicle 210. The camera 214 is disposed in the vehicle 210 and configured for capturing the plurality of driver images 181 of the driver 400 located on the driver's seat 241 in the vehicle 210. The local processing unit 220 is disposed in the vehicle 210 and includes the local training module 223, the confidence level determination module 224, the availability determination module 227, the presence determination module 228 and the detection module 230. The vehicle communication network 211 is disposed in the vehicle 210 and configured for communicatively connecting the self-driving unit 213, the camera 214, the vehicle body sensor 215, the alarming unit 216 and the local processing unit 220. The local processing unit 220 is configured to: capture the driver images 181 of the driver 400 by the camera 214; based on the driver images 181, by the detection module 230, detect whether the driver 400 satisfies the at least one face feature threshold, which is the at least one face detection result 188; determine whether the comprehensive confidence level is greater than or equal to the confidence level threshold based on the face detection result 188 by the confidence level determination module 224; by the availability determination module 227, determine whether the driver 400 satisfies an availability condition, which is an availability determination result, after the comprehensive confidence level is determined to be greater than or equal to the confidence level threshold; and determine whether a driving takeover condition is satisfied based on the availability determination result. Therefore, the driving takeover detecting system 200 according to the present disclosure is able to perform the image capturing step 120, the face feature detecting step 130, the confidence level determining step 140, the driver availability detecting step 160 and the driving takeover determining step 170 of the driving takeover detecting method 100, and it adapts the confidence level as the update criterion for model updating, so as to be suitable for changing and complex environments and scenes.

The driving takeover detecting system 200 may further include a local wireless communication unit 217 and the cloud server 270. The local wireless communication unit 217 is disposed in the vehicle 210. The vehicle communication network 211 is configured for communicatively connecting the self-driving unit 213, the camera 214, the local processing unit 220 and the local wireless communication unit 217. The cloud server 270 includes a cloud processing unit 280 and a cloud wireless communication unit 287. The cloud processing unit 280 includes the cloud training module 283 and the cloud classifier 284. The cloud processing unit 280 and the cloud wireless communication unit 287 are communicatively connected. The local processing unit 220 and the cloud processing unit 280 are communicatively connected via the local wireless communication unit 217 and the cloud wireless communication unit 287. The local processing unit 220 and the cloud processing unit 280 are configured to: upload the driver images 181 to the cloud server 270, after the comprehensive confidence level is determined to be less than the confidence level threshold; and use the driver images 181 to train the cloud classifier 284 by the cloud training module 283, wherein the cloud classifier 284 is similar to or configured for updating the detection module 230, and the cloud training module 283 is a machine learning algorithm. Therefore, the driving takeover detecting system 200 according to the present disclosure is able to perform the image uploading step 146 and the cloud training step 148. It is beneficial for the detection module 230 to update for changing and complex environments and scenes.

Regarding other details of the driving takeover detecting system 200 of the second embodiment, the contents of the driving takeover detecting method 100 of first embodiment may be referred, and the other details of the driving takeover detecting system 200 will not be described herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A driving takeover detecting method, for determining whether a driver located on a driver's seat in a vehicle satisfies a driving takeover condition in a self-driving mode, the driving takeover detecting method comprising:
an image capturing step comprising capturing a plurality of driver images of the driver by at least one camera;
a face feature detecting step comprising, based on the driver images, by a detection module, detecting whether the driver satisfies at least one face feature threshold, which is at least one face detection result;
a confidence level determining step comprising determining whether a comprehensive confidence level is greater than or equal to a confidence level threshold based on the at least one face detection result by a confidence level determination module;
a driver availability detecting step comprising, by an availability determination module, determining whether the driver satisfies an availability condition, which is an availability determination result, after the comprehensive confidence level is determined to be greater than or equal to the confidence level threshold in the confidence level determining step; and
a driving takeover determining step comprising determining whether the driving takeover condition is satisfied based on the availability determination result.

2. The driving takeover detecting method of claim 1, wherein the detection module comprises a personnel database, which comprises a plurality of personnel parameter sets respectively corresponding to a plurality of known personnel, each of the personnel parameter sets comprises a plurality of characteristic parameter values, and the driving takeover detecting method further comprises:
a face identifying step comprising identifying whether the driver is one of the known personnel; and
a posture feature detecting step comprising, based on the driver images, by the detection module, detecting whether the driver satisfies at least one posture feature threshold, which is at least one posture detection result;
wherein after the driver is identified as one of the known personnel in the face identifying step, the face feature detecting step and the posture feature detecting step are executed;
wherein the confidence level determining step comprises determining whether the comprehensive confidence level is greater than or equal to the confidence level threshold based on the at least one face detection result and the at least one posture detection result by the confidence level determination module.

3. The driving takeover detecting method of claim 2, further comprising:
a local training step, wherein after the driver is not identified as one of the known personnel in the face identifying step, the local training step is executed, the local training step comprises using the driver images to train the detection module by a local training module, and the local training module is a machine learning algorithm;
a personnel parameter set adding step comprising adding a personnel parameter set corresponding to the driver to the personnel database; and
a personnel database updating step comprising updating the personnel database;
wherein the image capturing step is executed after the personnel database updating step is executed.

4. The driving takeover detecting method of claim 2, further comprising:
an image uploading step, wherein after the comprehensive confidence level is determined to be less than the confidence level threshold in the confidence level determining step, the image uploading step is executed, and the image uploading step comprises uploading the driver images to a cloud server;
a cloud training step comprising using the driver images to train a cloud classifier by a cloud training module, the cloud classifier is similar to or configured for updating the detection module, and the cloud training module is a machine learning algorithm;
a personnel parameter set updating step comprising updating one of the personnel parameter sets corresponding to the driver of the cloud classifier; and
a personnel parameter set downloading step comprising downloading the updated personnel parameter set corresponding to the driver of the cloud classifier to the detection module;
wherein the confidence level threshold is based on a minimum confidence value that is positive in a confusion matrix.

5. The driving takeover detecting method of claim 4, wherein the cloud training step comprises fixing a part of the characteristic parameter values of one of the personnel parameter sets to train the cloud classifier by the cloud training module, and the personnel parameter set updating step comprises updating another part of the characteristic parameter values of the one of the personnel parameter sets of the cloud classifier.

6. The driving takeover detecting method of claim 5, wherein the cloud training step comprises labeling the driver images and using the labeled driver images to determine the part being fixed of the characteristic parameter values.

7. The driving takeover detecting method of claim 4, wherein the image uploading step is executed after the self-driving mode ends;
wherein the image capturing step is executed after the personnel parameter set downloading step is executed.

8. The driving takeover detecting method of claim 2, wherein the detection module comprises an eye-opening detection portion, a view angle detection portion and a head deflection detection portion;
wherein the face feature detecting step comprises:
an eye-opening detecting step comprising, based on the driver images, by the eye-opening detection portion, detecting whether the driver satisfies an eye-opening feature threshold, which is an eye-opening detection result;
a view angle detecting step comprising, based on the driver images, by the view angle detection portion, detecting whether the driver satisfies a view angle feature threshold, which is a view angle detection result; and
a head deflection detecting step comprising, based on the driver images, by the head deflection detection portion, detecting whether the driver satisfies a head deflection feature threshold, which is a head deflection detection result;
wherein a number of the at least one face detection result is at least three, and the face detection results comprise the eye-opening detection result, the view angle detection result and the head deflection detection result;
wherein the confidence level determining step comprises calculating an eye-opening confidence level, a view angle confidence level, a head deflection confidence level and a posture confidence level respectively based on the eye-opening detection result, the view angle detection result, the head deflection detection result and the at least one posture detection result by the confidence level determination module, and calculating the comprehensive confidence level based on the eye-opening confidence level, the view angle confidence level, the head deflection confidence level and the posture confidence level by the confidence level determination module.

9. The driving takeover detecting method of claim 8, wherein in the confidence level determining step, the eye-opening confidence level, the view angle confidence level, the head deflection confidence level and the posture confidence level respectively have an eye-opening weight, a view angle weight, a head deflection weight and a posture weight for calculating the comprehensive confidence level by the confidence level determination module, and each of the eye-opening weight and the view angle weight is greater than each of the head deflection weight and the posture weight;
wherein the characteristic parameter values of the personnel parameter set corresponding to each of the known personnel comprise the eye-opening feature threshold, the view angle feature threshold, the head deflection feature threshold, the at least one posture feature threshold, the eye-opening weight, the view angle weight, the head deflection weight and the posture weight.

10. The driving takeover detecting method of claim 9, wherein at least one of the eye-opening feature threshold, the view angle feature threshold, the head deflection feature threshold and the at least one posture feature threshold has thresholds respectively applicable to an unobstructed face state and at least one obstructed face state, and the obstructed face state indicates a face of the driver is obstructed by an object.

11. The driving takeover detecting method of claim 1, further comprising:
a confidence level adjusting step, wherein after the comprehensive confidence level is determined to be greater than or equal to the confidence level threshold in the confidence level determining step, the confidence level adjusting step is executed, and the confidence level adjusting step comprises increasing or decreasing the comprehensive confidence level based on a ratio and a duration of an appearance of a same image or a similar image in the driver images.

12. The driving takeover detecting method of claim 1, further comprising:
a vehicle body signal acquiring step comprising acquiring a plurality of vehicle body signals of the driver's seat by at least one vehicle body sensor, wherein the vehicle body signals comprise at least partial signals of a plurality of seat belt buckle signals and a plurality of driver's seat pressure signals;
a driver presence detecting step comprising, based on at least one of the driver images and the vehicle body signals, by a presence determination module, determining whether the driver satisfies a presence condition, which is a presence determination result; and
an alarming step;
wherein the driving takeover determining step comprises determining whether the driving takeover condition is satisfied based on the availability determination result and the presence determination result;
wherein after the driving takeover condition is not satisfied in the driving takeover determining step, the alarming step is executed, and the alarming step comprises generating at least one of a visual alarm, an auditory alarm and a vibration alarm to alarm the driver.

13. A driving takeover detecting system, comprising:
a self-driving unit disposed in a vehicle and configured for executing a self-driving mode of the vehicle;
at least one camera disposed in the vehicle and configured for capturing a plurality of driver images of a driver located on a driver's seat in the vehicle;
a local processing unit disposed in the vehicle and comprising a detection module, a confidence level determination module and an availability determination module; and
a vehicle communication network disposed in the vehicle and configured for communicatively connecting the self-driving unit, the at least one camera and the local processing unit;
wherein the local processing unit is configured to:
capture the driver images of the driver by the at least one camera;
based on the driver images, by the detection module, detect whether the driver satisfies at least one face feature threshold, which is at least one face detection result;
determine whether a comprehensive confidence level is greater than or equal to a confidence level threshold based on the at least one face detection result by the confidence level determination module;
by the availability determination module, determine whether the driver satisfies an availability condition, which is an availability determination result, after the comprehensive confidence level is determined to be greater than or equal to the confidence level threshold; and
determine whether a driving takeover condition is satisfied based on the availability determination result.

14. The driving takeover detecting system of claim 13, further comprising:
a local wireless communication unit disposed in the vehicle, wherein the vehicle communication network is configured for communicatively connecting the self-driving unit, the at least one camera, the local processing unit and the local wireless communication unit; and
a cloud server comprising a cloud processing unit and a cloud wireless communication unit, wherein the cloud processing unit comprises a cloud training module and a cloud classifier, the cloud processing unit and the cloud wireless communication unit are communicatively connected, and the local processing unit and the cloud processing unit are communicatively connected via the local wireless communication unit and the cloud wireless communication unit;
wherein the local processing unit and the cloud processing unit are configured to:
upload the driver images to the cloud server, after the comprehensive confidence level is determined to be less than the confidence level threshold; and
use the driver images to train the cloud classifier by the cloud training module, wherein the cloud classifier is similar to or configured for updating the detection module, and the cloud training module is a machine learning algorithm.
